(19) United States
(12) Patent Application Publication
(10) Pub. No.: US 2009/0113174 A1
(43) Pub. Date: Apr. 30, 2009

(54) Sign Operation Instructions and Circuitry

(75) Inventors: Tod David Wolf, Richardson, TX (US); Eric Biscondi, Opio (FR); David John Hoyle, Sugar Land, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/930,958

(22) Filed: Oct. 31, 2007

(51) Int. Cl. G06F 9/305; G06F 15/76; G06F 9/02

(52) U.S. Cl. 712/34; 712/223; 712/E09.002; 712/E09.018

(57) ABSTRACT

A co-processor for efficiently decoding codewords encoded according to a Low Density Parity Check (LDPC) code, and arranged to efficiently execute an instruction to multiply the value of one operand with the sign of another operand, is disclosed. Logic circuitry is included in the co-processor to select between the value of a second operand, and an arithmetic inverse of the second operand value, in response to the sign bit of the first operand. This logic circuitry is arranged to operate according to 2's-complement integer arithmetic, by also including invert-and-increment circuitry to produce a 2's-complement inverse of the second operand. A comparator determines whether the second operand is at a maximum 2's-complement negative value, in which case the arithmetic inverse is selected to be a hard-wired maximum 2's-complement positive value. Logic circuitry is also included in the co-processor to execute an instruction to multiple the signs of two operands; this logic circuitry is realized as an exclusive-OR function operating on the sign bits of the operands, and a multiplexer for selecting between digital words of the values +1 and −1 in response to the exclusive-OR function. The logic circuitry can be arranged in multiple blocks in parallel, to provide parallel execution of the instruction in wide datapath processors.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Embodiments of this invention are in the field of digital logic, and are more specifically directed to programmable logic suitable for use in computationally intensive applications such as low density parity check (LDPC) decoding.

High-speed data communication services, for example in providing high-speed Internet access, have become a widespread utility for many businesses, schools, and homes. In its current stage of development, this access is provided by an array of technologies. Recent advances in wireless communications technology have enabled localized wireless network connectivity according to the IEEE 802.11 standard to become popular for connecting computer workstations and portable computers to a local area network (LAN), and typically through the LAN to the Internet. Broadband wireless data communication technologies, for example those technologies referred to as “WiMAX” and “WiBro”, and those technologies according to the IEEE 802.16d/e standards, have also been developed to provide wireless DSL-like connectivity in the Metro Area Network (MAN) and Wide Area Network (WAN) context.

A problem that is common to all data communications technologies is the corruption of data by noise. As is fundamental in the art, the signal-to-noise ratio for a communications channel is a degree of goodness of the communications carried out over that channel, as it conveys the relative strength of the signal that carries the data (as attenuated over distance and time), to the noise present on that channel. These factors relate directly to the likelihood that a data bit or symbol as received differs from the data bit or symbol as transmitted. This likelihood of a data error is reflected by the error probability for the communications over the channel, commonly expressed as the Bit Error Rate (BER) ratio of errored bits to total bits transmitted. In short, the likelihood of error in data communications must be considered in developing a communications technology. Techniques for detecting and correcting errors in the communicated data must be incorporated for the communications technology to be useful.

Error detection and correction techniques are typically implemented by the technique of redundant coding. In general, redundant coding inserts data bits into the transmitted data stream that do not add any additional information, but that indicate, on decoding, whether an error is present in the received data stream. More complex codes provide the ability to deduce the true transmitted data from a received data stream even if errors are present.

Many types of redundant codes that provide error correction have been developed. One type of code simply repeats the transmission, for example by sending the payload followed by two repetitions of the payload, so that the receiver deduces the transmitted data by applying a decoder that determines the majority vote of the three transmissions for each bit. Of course, this simple redundant approach does not necessarily correct every error, but greatly reduces the payload data rate. In this example, a predictable likelihood exists that two of three bits are in error, resulting in an erroneous majority vote despite the useful data rate having been reduced to one-third. More efficient approaches, such as Hamming codes, have been developed toward the goal of reducing the error rate while maximizing the data rate.

The well-known Shannon limit provides a theoretical bound on the optimization of decoder error as a function of data rate. The Shannon limit provides a metric against which codes can be compared, both in the absolute sense and also in comparison with one another. Since the time of the Shannon proof, modern data correction codes have been developed to more closely approach the theoretical limit, and thus maximize the data rate for a given tolerable error rate. An important class of these conventional codes is referred to as the Low Density Parity Check (LDPC) codes. The fundamental paper describing these codes is Gallager, Low-Density Parity-Check Codes, (MIT Press, 1963), monograph available at http://www.inference.phy.cam.ac.uk/mackay/gallager/papers/. In these codes, a sparse matrix H defines the code, with the encodings c of the payload data satisfying:

Hc=0 (1)

over Galois field GF(2). Each encoding c consists of the source message cᵢ combined with the corresponding parity check bits cₚ for that source message cᵢ. The encodings c are transmitted, with the receiving network element receiving a signal vector r=c+n, n being the noise added by the channel. Because the decoder at the receiver also knows matrix H, it can compute a vector z=Hr. However, because r=c+n, and because Hc=0:

z=Hr=Hc+Hn=Hn (2)

The decoding process thus involves finding the most sparse vector x that satisfies:

Hx=z (3)

over GF(2). This vector x becomes the best guess for noise vector n, which can be subtracted from the received signal vector r to recover encodings c, from which the original source message cᵢ is recoverable.

FIG. 1 illustrates a typical implementation of LDPC encoding and decoding in a communications system. In this system, transmitting transceiver 10 is transmitting LDPC encoded data to receiving transceiver 20 as modulated signals over transmission channel C. For example, transmitting transceiver 10 may be realized in a wireless access point for OFDM communications as contemplated for IEEE 802.11 wireless networking, or such other communications or network transceiver. The data flow in this approach is also analogous to Discrete Multitone modulation (DMT) as used in conventional DSL communications, as known in the art. In the system of FIG. 1, while only one direction of transmission is shown, it will of course be understood by those skilled in the art that data will also be communicated in the opposite direction, in which case transceiver 20 will be transmitting signals to transceiver 10.

As shown in FIG. 1, transmitting transceiver 10 receives an input bitstream that is to be transmitted to receiving transceiver 20. The input bitstream may be generated by a computer at the same location (e.g., the central office) as transmitting transceiver 10, or alternatively and more likely is generated by a computer network, in the Internet sense, that is coupled to transmitting transceiver 10. Typically, this input bitstream is a serial stream of binary digits, in the appropriate format as produced by the data source. This input bitstream is received by LDPC encoder function 11, which digitally encodes the input bitstream by applying a redundant code for error detection and correction purposes. An example of encoder function 11 according to the preferred embodiment of the invention is described in U.S. Pat. No. 7,162,684, commonly assigned herewith and incorporated herein by this reference. In general, as mentioned above, the coded bits include both the payload data bits and also code bits that are selected, based on the payload bits, so that the application of the codeword (payload plus code bits) to the sparse LDPC parity check matrix equals zero for each parity check row. After application of the LDPC code, modulator function 12 groups the incoming bits into symbols and, in this OFDM example, modulates the various subchannels in the OFDM broadband transmission, for example by way of an inverse Discrete Fourier Transform (IDFT).

These modulated signals are converted into a serial sequence, filtered and converted to analog levels, and then transmitted over transmission channel C to receiving transceiver 20. The transmission channel C will of course depend upon the type of communications being carried out. In the wireless communications context, the channel will be the particular environment through which the wireless transmission takes place. Alternatively, in a DSL context, the transmission channel is physically realized by conventional twisted-pair wire. In any case, transmission channel C adds significant distortion and noise to the transmitted analog signal, which can be characterized in the form of a channel impulse response.

This transmitted signal is received by receiving transceiver 20, which, in general, reverses the processes of transmitting transceiver 10 to recover the information of the input bitstream. As shown contextually in FIG. 1, receiving transceiver 20 includes demodulator function 22, which applies analog-to-digital conversion, filtering, serial-to-parallel conversion, demodulation (e.g., by way of a DFT), and symbol to bit decoding, to recover LDPC codewords, in combination with such noise, attenuation, and other distortion that may have been added over transmission channel C. LDPC decoder 24 recovers its estimates of the original bitstream that was encoded by LDPC encoder 11, prior to transmission, according to known techniques. The distortion and noise added during transmission is, in theory if not practice, eliminated from the recovered bitstream by virtue of the redundant coding applied by the LDPC technique, as mentioned above.

There are many known implementations of LDPC codes. Some of these LDPC codes have been described as providing code performance that approaches the Shannon limit, as described in MacKay et al., “Comparison of Constructions of Irregular Gallager Codes”, Trans. Comm., Vol. 47, No. 10 (IEEE, October 1999), pp. 1449-54, and in Tanner et al., “A Class of Group-Structured LDPC Codes”, ISTCA-2001 Proc. (Ambleside, England, 2001).

In theory, the encoding of data words according to an LDPC code is straightforward. Given sufficient memory or sufficiently small data words, one can store all possible code words in a lookup table, and look up the code word in the table corresponding to the data word to be transmitted. But modern data words to be encoded are on the order of 1 kbits and larger, rendering lookup tables prohibitively large and cumbersome. Accordingly, algorithms have been developed that derive codewords, in real time, from the data words to be transmitted. A straightforward approach for generating a codeword is to consider the n-bit codeword vector c in its systematic form, having a data or information portion cᵢ and an m-bit parity portion cₚ such that the resulting codeword vector c=(cᵢ|cₚ). Similarly, parity matrix H is placed into a systematic form H_{sys}, preferably in a lower triangular form for the m parity bits. In this conventional encoder, the information portion cᵢ is filled with n-m information bits, and the m parity bits are derived by back-substitution with the systematic parity matrix H_{sys}. This approach is described in Richardson and Urbanke, “Efficient Encoding of Low-Density Parity-Check Codes”, IEEE Trans. on Information Theory, Vol. 47, No. 2 (February 2001), pp. 638-656. This article indicates that, through matrix manipulation, the encoding of LDPC codewords can be accomplished in a number of operations that approaches a linear relationship with the size n of the codewords.

More efficient LDPC encoders have been developed in recent years. An example of such an improved encoder architecture is described in U.S. Pat. No. 7,162,684, commonly assigned herewith and incorporated herein by this reference. The selecting of a particular codeword arrangement according to modern techniques is described in U.S. Patent Application Publication No. US 2006/0123277 A1, commonly assigned herewith and incorporated herein by this reference.

On the decoding side, it has been observed that high-performance LDPC code decoders are difficult to implement into hardware. While Shannon's adage holds that random codes are good codes, it is regularity that allows efficient hardware implementation. To address this difficult tradeoff between code irregularity and hardware efficiency, the well-known belief propagation technique provides an iterative implementation of LDPC decoding that can be made somewhat efficient, as described in Richardson, et al., “Design of Capacity-Approaching Irregular Low-Density Parity Check Codes,” IEEE Trans. on Information Theory, Vol. 47, No. 2 (February 2001), pp. 619-637; and in Zhang et al., “VLSI Implementation-Oriented (3,k)-Regular Low-Density Parity-Check Codes”, IEEE Workshop on Signal Processing Systems (September 2001), pp. 25.-36. Belief propagation decoding algorithms are also referred to in the art as probability propagation algorithms, message passing algorithms, and as sum-product algorithms.

In summary, belief propagation algorithms are based on the binary parity check property of LDPC codes. As mentioned above and as known in the art, each check vertex in the LDPC code constrains its neighboring variables to form a word of even parity. In other words, the product of the correct LDPC code word vector with each row of the parity check matrix sums to zero. According to the belief propagation approach, the received data are used to represent the input probabilities at each input node (also referred to as a “bit node”) of a bipartite graph having input nodes and check nodes.

FIG. 2a illustrates an example of such a bipartite graph of the conventional belief propagation algorithm. In FIG. 2a, the “variable” or input nodes V1 through V8 correspond to corresponding received signal bit values, as may be modified or updated by the belief propagation algorithm. The checksum or “check” nodes S1 through S4 correspond to the sum of those variable nodes V1 through V8 selected by the LDPC code. For a valid codeword represented by the values of variable nodes V1 through V8, all checksum nodes S1 through S4 will have a value of zero. In this example, check node S1 represents the sum of the values of variable nodes V2, V3, V4, V5; check node S2 represents the sum of the values of variable nodes V1, V3, V6, V7; and so on as shown in FIG. 2a. The task of the belief propagation algorithm is to determine the values of variable nodes V1 through V8 that evaluate to the correct checksum of all check nodes S1 through S4 equaling zero, but beginning from the received signal values (and thus including the transmitted signal values as distorted by noise, etc.). This determination is performed in an iterative manner, as will now be summarized.

Within each iteration of the belief propagation method, bit probability messages are passed from the input nodes V to the check nodes S, updated according to the parity check constraint, with the updated values sent back to and summed at the input nodes V. The summed inputs are formed into log likelihood ratios (LLRs) defined as:

$$L ( c ) = log ( \frac{P ( c = 0 )}{P ( c = 1 )} ) \qquad ( 4 )$$

where c is a coded bit received over the channel. The value of any given LLR L(c) can of course take negative and positive values, corresponding to 1 and 0 being more likely, respectively. The index c of the LLR L(c) indicates the variable node Vc to which the value corresponds, such that the value of LLR L(c) is a “soft” estimate of the correct bit value for that node. In its conventional implementation, the belief propagation algorithm uses two value arrays, a first array L storing the LLRs for j input nodes V, and the second array R storing the results of m parity check node updates, with m being the parity check row index and j being the column (or input node) index of the parity check matrix H. The general operation of this conventional approach determines, in a first step, the R values by estimating, for each check sum S (each row of the parity check matrix), the probability of the input node value from the other inputs used in that checksum. The second step of this algorithm determines the LLR probability values of array L by combining, for each column, the R values for that input node from parity check matrix rows in which that input node participated. A “hard” decision is then made from the resulting probability values, and is applied to the parity check matrix. This two-step iterative approach is repeated until the parity check matrix is satisfied (all parity check rows equal zero), or until another convergence criteria is reached, or until a terminal number of iterations have been executed.

In other words, LDPC decoding process involves the iterative two-step process of:
1. Estimate a value Rₘⱼ for each of the j input nodes Vⱼ at each of the m checksum nodes C, using the current probability values from the other input nodes contributing to that checksum node Cₘ, and setting the result of the checksum node Cₘ for row m to 0; and
2. Update the sum L(qⱼ) for each of the j input nodes V from a combination of the Rₘⱼ values for that same input node Vⱼ (column).
   The iterations continue until a termination criterion is reached, as mentioned above.

In practice, the process begins with an initialized estimate for the LLRs L(rⱼ), ∀ⱼ, using the received soft data. Typically, for AWGN channels, this initial estimate is

$$- 2 {r}_{j} / {σ}^{2} ,$$

as known in the art, where rⱼ is the received soft symbol value for variable node Vⱼ. The values of check nodes S (i.e., the matrix rows) are also each initialized to zero (Rₘⱼ=0, for all m and all j), corresponding to the result for a correct codeword. The per-row (or extrinsic) LLR probabilities are then derived:

L(qₘⱼ)=L(qⱼ)−Rₘⱼ (1)

for each column j of each row m of the checksum subset. As shown in FIG. 2a, by way of example, the value L(q_{1,3}) corresponds to the LLR of the value at variable node V1 (matrix column j=1) as determined by the evaluation of check node S3 (matrix row m=3). These per-row probabilities amount to an estimate for the probability of the value of the variable node V, excluding row m's own contribution to that estimate L(qₘⱼ) for row m. As shown in FIG. 2, these values L(qₘⱼ) are “passed” to the checksum nodes S, to update the check node values Rₘⱼ. According to conventional techniques, this update is performed by deriving amplitude Aₘⱼ as follows:

$${A}_{mj} = {\sum }_{n ∈ N ( m ) ; n \neq j} Ψ ( L ( {q}_{mn} ) ) \qquad ( 2 )$$

for each input node Vⱼ contributing to a given checksum row m. In effect, the amplitude Aₘⱼ for a column j based on row m, is the sum of the values of a function of those estimates L(qₘⱼ) that contribute to the checksum for that row m, other than the estimate for column j itself. An example of a suitable function Ψ is:

Ψ(x)≡log(|tan h(x/2)|) (3)

A sign value sₘⱼ is determined from:

$${s}_{mj} = {\prod }_{n ∈ N ( m ) ; n \neq j} sgn ( L ( {q}_{mn} ) ) \qquad ( 4 )$$

which is simply an odd/even determination of the number of negative probabilities for a checksum m, excluding column j's own contribution to that checksum m. The updated estimate of each value Rₘⱼ then becomes:

Rₘⱼ=−sₘⱼΨ(Aₘⱼ) (5)

The negative sign of value Rₘⱼ contemplates that the function Ψ is its own negative inverse. The value Rₘⱼ thus corresponds to an estimate of the LLR for input node Vj as derived from the other input nodes V that contributed to the mth row of the parity check matrix (check node Sₘ), not using the value for input node j itself. As shown in FIG. 2a, these values Rₘⱼ are then “passed back” to the variable, or input, nodes S so that the LLRs for those variable nodes can be updated.

Therefore, in the second step of each decoding iteration, the LLR estimates for each input node are updated over each matrix column (i.e., each input node V) as follows:

$$L ( {q}_{j} ) = {\sum }_{m ∈ M ( j )} {R}_{mj} - \frac{2 {r}_{j}}{{σ}^{2}} \qquad ( 6 )$$

where the estimated value Rₘⱼ is the most recent update, from equation (5) in this derivation, summed over the other variable nodes V contributing to the checksum for row m, minus the original estimate of the value at variable node Sⱼ. This column estimate L(qⱼ) can then be used to make a “hard” decision check, as mentioned above, to determine whether the iterative belief propagation algorithm can be terminated.

In conventional communications system, the function of LDPC decoding, specifically by way of the belief propagation algorithm, is typically implemented in a sequence of program instructions, as executed by programmable digital logic. For example, the implementation of LDPC decoding in a communications receiver by way of a programmable digital signal processor (DSP) device, such as a member of the C64x family of digital signal processors available from Texas Instruments Incorporated, is commonplace in the art. Following the above description of the belief propagation algorithm, the instructions involved in the updating of the check node values Rₘⱼ include the evaluation of equations (3) through (5). Typically, it is contemplated that the evaluation of the function Ψ will typically involve a look-up table access, or alternatively a straightforward arithmetic calculation of an estimate.

Each update also involves the evaluation of the sign value sₘⱼ as indicated in equation (4); alternatively, this evaluation of the sign value sₘⱼ may derive the negative sign value −sₘⱼ, since this negative value is applied in equation (5) in each case. For the example of FIG. 2a, considering check node S2, four sign values (i.e., s_{2,1}, s_{2,3}, s_{2,6}, and s_{2,7}) must be derived. As discussed above, each of these sign values is derived from the sign of the extrinsic LLR values L(qₘⱼ) for the other variable nodes V involved in the same checksum:

s_{2,1}=−sgn[L(q_{2,3})]*sgn[L(q_{2,6})]*sgn[L(q_{2,7})] (7a)

s_{2,3}=−sgn[L(q_{2,1})]*sgn[L(q_{2,6})]*sgn[L(q_{2,7})] (7b)

s_{2,6}=−sgn[L(q_{2,1})]*sgn[L(q_{2,3})]*sgn[L(q_{2,7})] (7c)

s_{2,7}=−sgn[L(q_{2,1})]*sgn[L(q_{2,3})]*sgn[L(q_{2,6})] (7d)

where sgn is the “sign” function, returning the polarity of its respective argument. As evident from equations (7a) through (7d), each instance of sgn[L(qₘⱼ)] is used three times in these four equations. Accordingly, the set of four equations can be simplified, in the number of multiplications required, by evaluating a product P of all four sgn values:

P=−1*sgn[L(q_{2,1})]*sgn[L(q_{2,3})]*sgn[L(q_{2,6})]*sgn[L(q_{2,7})] (8)

and then calculating each sign value sₘⱼ as the product of this product value P with the sign value of its own extrinsic LLR value L(qₘⱼ):

s_{2,1}=P*sgn[L(q_{2,1})] (9a)

s_{2,3}=P*sgn[L(q_{2,3})] (9b)

s_{2,6}=P*sgn[L(q_{2,6})] (9c)

s_{2,7}=P*sgn[L(q_{2,7})] (9d)

These sign values sₘⱼ can then be multiplied by their respective amplitude function values Ψ(Aₘⱼ) to derive the updated row values Rₘⱼ:

R_{2,1}=s_{2,1}*Ψ(A_{2,1}) (10a)

R_{2,3}=s_{2,3}*Ψ(A_{2,3}) (10b)

R_{2,6}=s_{2,6}*Ψ(A_{2,6}) (10c)

R_{2,7}=s_{2,7}*Ψ(A_{2,7}) (10d)

In general, for any row m and column j, the updated row value Rₘⱼ can thus be derived as:

Rₘⱼ=sₘⱼ*Ψ(Aₘⱼ) (10e)

As mentioned above, these calculations are typically done via software, executed by a DSP device, in conventional receiving equipment that is carrying out LDPC decoding. As known in the art, most instruction sets (including those of the C64x DSP devices available from Texas Instruments Incorporated) include a “SGN” function, implementing the evaluation z=SGN(x). This z=SGN(x) function can be defined arithmetically as follows:
if x>=0; then z=1
if x<0; then z=−1
   In order to realize equation (10e) by way of software instructions executed by a DSP, as performed in conventional LDPC decoding as described above, it is therefore necessary to execute the SGN(x) function along with a multiplication of an attribute value (the value of Ψ(Aₘⱼ), as previously evaluated). Typically, this is implemented without an explicit multiplication in a manner described by the following C code, using 2's-complement arithmetic, to execute the operation of z=SGN(x)*Ψ(Aₘⱼ):

| | |
|---|---|
| z = y; | **** y corresponds to the value Ψ(Aₘⱼ) |
| if (x < 0) { | |
| if (y = −2ⁿ) { | * n = data word width; does y = max neg value? |
| z = 2ⁿ − 1; | *** yes => set z to max positive value |
| } else { | |
| z = − 1 * y | *** negate y because x is negative |
| } | |
| } | *** if x>=0, do nothing |
| return(z); | |

As mentioned above, this LDPC decoding operation is conventionally executed by DSP devices, such as a member of the C64x family of DSPs available from Texas Instruments Incorporated. This conventional operation can be coded in C64x assembly code as follows:

| | | | |
|---|---|---|---|
| | ZERO | A0 | initialize register A0 |
| | MVK | A1,0x8000 | set A1 to −2ⁿ |
| | CMPLT | X, A0, B0 | X < 0?; store result in B0 |
| | CMPEQ | Y, A1, B1 | Y= max neg value?; result in B1 |
| | AND | B0, B1, B2 | if both B0 and B1 are true, set B2 |
| | MV | X, Z | assign value of X to Z |
| [B2] | MVK | Z, 0x7FFF | If B2, then Z= max positive value |
| [B2] | ZERO | B0 | and reset B0 |
| [B0] | MPY | Y, −1, Z | If B0, negate Y and store in Z |

As evident from this assembly code, nine C64x DSP assembly instructions are required to carry out the operation of equation 10(e) to update the row value Rₘⱼ for a single row m and column j in the decoding process. The latency of each of the non-conditional instructions in this sequence is one machine cycle each; any of the conditional instructions, if executed, have a latency of six cycles according to the C64x DSP architecture. The maximum machine cycle latency for this sequence is therefore eighteen machine cycles, for the case in which B2 is set (i.e., SGN(X) is negative and the attribute value Y is at its maximum negative value).

Machine cycle latency is an important issue, of course, especially in time-sensitive operations such as LDPC decoding, for example such decoding of real-time communications (e.g., VoIP telephony). Another important issue in considering the efficiency and performance of the LDPC decoding process is the number of calculations required to carry out this operation for a typical LDPC code word. For example, under the IEEE 802.16e WiMAX communications standard, a typical code has a ¾ code rate, with a codeword size of 2304 bits and 576 checksum nodes; in this case, as many as fifteen input nodes V may contribute to a given checksum node S (i.e., the maximum row weighting is fifteen). For this example, assuming a modest number of fifty LDPC decoding iterations, the number of instructions to be executed in order to evaluate equation (10e) for a single code word requires 3,888,000 machine cycles. This level of computational effort is, of course, substantial for time-critical applications such as LDPC decoding.

By way of further background, the LDPC decoding process above involves another costly process, as measured by machine cycles. Specifically, it is known in the art to evaluate the amplitude Aₘⱼ by evaluating equations (2) and (3) as:

Aₘⱼ(x,y)=sgn(x)sgn(y)min(|x|,|y≡)+log(1+e^{-|x+y|})−log(1+e^{-|x-y|}) (11)

with the sgn(x) function defined as above. FIG. 2b illustrates the values of the log equation (i.e., the term log(1+exp−|x|), by way of curve 20. Typically, the evaluation of these log values are performed by function calls, each requiring several machine cycles, by addressing a look-up table of pre-calculated values, or by way of an estimate (considering the iterative nature of the decoding process). Curve 21 of FIG. 2b illustrates a relatively coarse estimate for this function that is used in some conventional decoders, to facilitate this calculation.

The remainder of equation (11), namely the function:

ƒ(x,y)=sgn(x)sgn(y) (12)

requires the calling and executing of several functions. For example, a conventional C code sequence for this function ƒ(x,y)=z=sgn(x)sgn(y) in equation (12) can be written:

| | |
|---|---|
| if ((x < 0) && (y<0)){ z=1 | *both x and y are negative |
| } else if ((x>=0)&&(y>=0) {z=1 | *both x and y are positive |
| } else { | |

z =− 1; * one negative and one positive
}
return(z);

This sequence can be written in C64x assembly code as follows:

| | | | |
|---|---|---|---|
| | ZERO | A0 | initialize register A0 |
| | CMPLT | X, A0, A1 | X < 0?; store result in A1 |
| | CMPLT | Y, A0, A2 | Y< 0>; store result in A2 |
| | XOR | A1, A2, A3 | if B0 and B1 are not the same, set B0 |
| | MVK | 1, A3 | move “1” to A3 if B0 is not set |
| [B0] | MVK | −1, A3 | move “−1” to A3 if B0 is set |

The evaluation of the function ƒ(x,y)=z=sgn(x)sgn(y), as part of the evaluation of equation (11), thus requires the execution of six instructions, and involves a latency of eleven machine cycles, considering the conditional MVK instruction to itself have a latency of six machine cycles. But this sequence must be repeated many times in the LDPC decoding of each code word, specifically in each row update iteration. For the example used above for the IEEE 802.16e WiMAX communications standard, at a ¾ code rate, with a codeword size of 2304 bits and 576 checksum nodes, and a maximum row weighting is fifteen, the number of machine cycles required for the function of equation (12) amounts to about 2,592,000 machine cycles (50×576×15×6).

### BRIEF SUMMARY OF THE INVENTION

Embodiments of this invention provide a method and circuitry that improve the efficiency of redundant code decoding in modern digital circuitry, particularly such decoding as performed iteratively.

Embodiments of this invention provide such a method and circuitry that can reduce the number of machine cycles required to perform a calculation useful in such decoding.

Embodiments of this invention provide such a method and circuitry that can reduce the machine cycle latency for such decoding calculations.

Embodiments of this invention provide such a method and circuitry that can be used in place of calculations in general arithmetic and logic instructions.

Embodiments of this invention provide such a method and circuitry that can be efficiently implemented into programmable digital logic, by way of instructions and dedicated logic for executing those instructions.

Embodiments of the invention may be implemented into an instruction executed by programmable digital logic circuitry, and into a circuit within such digital logic circuitry. The instruction has two arguments, one argument being a signed value, the sign of which determines whether to invert the sign of a second argument, which is also a signed value. The instruction returns a value that has a magnitude equal to that of the second argument, and that has a sign based on the sign of the second argument, inverted if the sign of the first argument is negative.

Embodiments of the invention may also be implemented in circuitry for executing this instruction, in the form of a first multiplexer for selecting between the second argument and a positive maximum value, depending on a comparison of the second argument value relative to a negative maximum value, and a second multiplexer for selecting between the second argument value itself and the output of the first multiplexer, depending on the sign of the first argument.

Embodiments of the invention may also be implemented into another instruction executed by programmable digital logic circuitry, and into a circuit within such digital logic circuitry. This instruction has two arguments, both signed values. An exclusive-OR of the sign bits of the two arguments controls a multiplexer to select between a 2's-complement “1” value for the desired level of precision (e.g., 0b00000001) or a 2's-complement “−1” value (e.g., 0b11111111). Circuitry can be constructed to perform this operation in a single machine cycle, by way of a single bit XOR and a multiplexer. This circuitry can be easily parallelized for wide data path processors.

### BRIEF DESCRIPTION OF THE SEVERAL VIEWS OF THE DRAWING

FIG. 1 is an electrical diagram, in block form, of a conventional system for communicating digital data, encoded according to a low density parity check (LDPC) code.

FIG. 2a is a diagram, in Tanner diagram form, of a conventional LDPC decoder according to a belief propagation algorithm.

FIG. 2b is a plot of the evaluation of a log function, and an estimate for the log function, in conventional LDPC decoding.

FIG. 3 is an electrical diagram, in block form, of a network communications transceiver constructed according to the preferred embodiment of the invention.

FIG. 4 is an electrical diagram, in block form, of a digital signal processor (DSP) subsystem in the transceiver of FIG. 3, constructed according to the preferred embodiment of the invention.

FIG. 5 is an electrical diagram, in block and schematic form, of a logic block within an DSP co-processor of the DSP subsystem of FIG. 4, for performing a SGNFLIP operation, and constructed according to the preferred embodiment of the invention.

FIGS. 6a and 6b are register-level diagrams illustrating the arrangement of logic blocks within the DSP co-processor of FIG. 5, for performing SGNFLIP operations on one or more than one data words, according to the preferred embodiment of the invention.

FIG. 6c is a register-level diagram illustrating the arrangement of logic blocks within the DSP co-processor of FIG. 5, for performing SGNPROD operations on multiple data words, according to the preferred embodiment of the invention.

FIG. 7 is an electrical diagram, in block and schematic form, of a logic block within an DSP co-processor of the DSP subsystem of FIG. 4, for performing a SGNPROD operation, and constructed according to the preferred embodiment of the invention.

FIG. 8 is an electrical diagram, in block form, of a cluster architecture for the DSP co-processor in the DSP subsystem of FIG. 4, into which the logic blocks for performing the SGNFLIP or SGNPROD instructions, or both, according to the preferred embodiments of the invention can be implemented.

FIG. 9 is an electrical diagram, in block form, of one of the sub-clusters in the cluster architecture DSP co-processor of FIG. 8.

### DETAILED DESCRIPTION OF THE INVENTION

The invention will be described in connection with its preferred embodiment, namely as implemented into programmable digital signal processing circuitry in a communications receiver. However, it is contemplated that this invention will also be beneficial when implemented into other devices and systems, and when used in other applications that utilize the types of calculations performed by this invention. Accordingly, it is to be understood that the following description is provided by way of example only, and is not intended to limit the true scope of this invention as claimed.

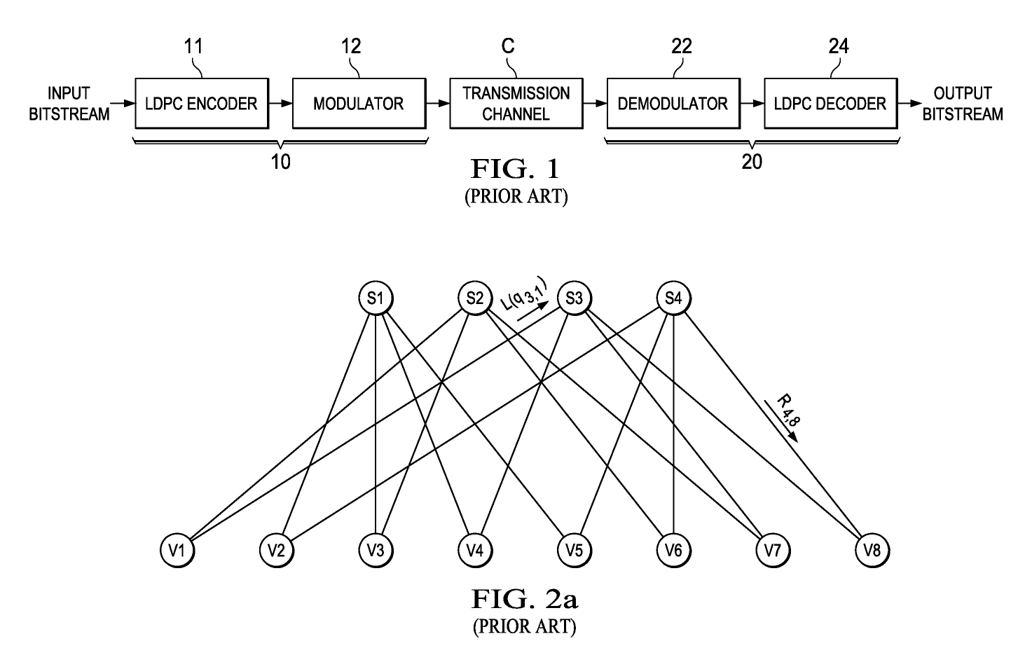

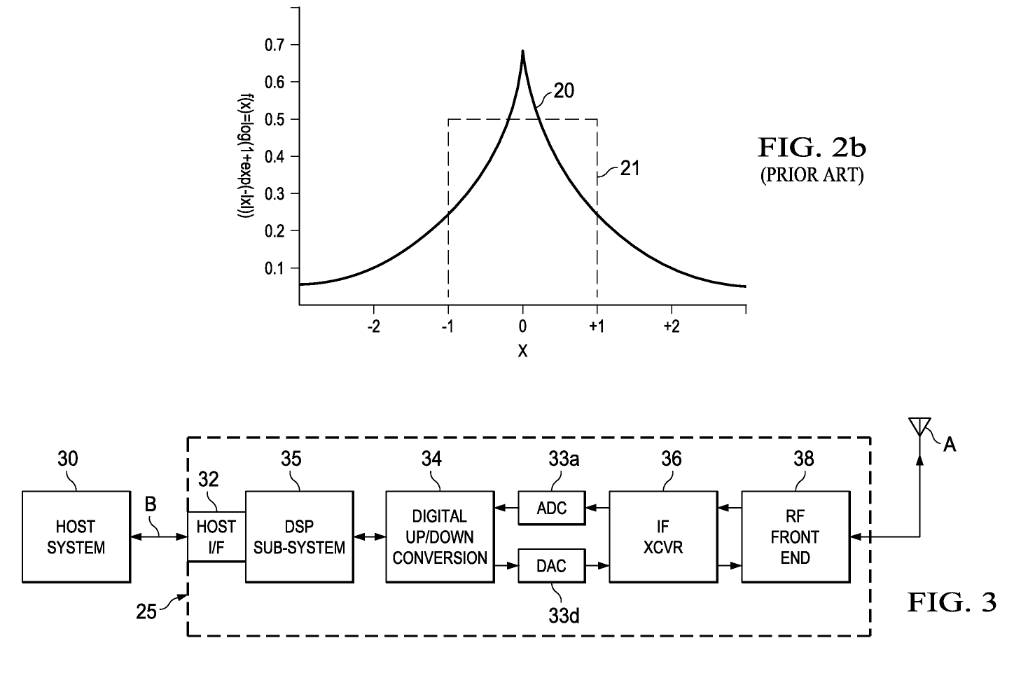

FIG. 3 illustrates an example of the construction of wireless network adapter 25, constructed according to the preferred embodiment of this invention. In this example, and in the context of the decoding functions carried out by the preferred embodiment of this invention, wireless network adapter 25 operates as a receiver of wireless communications signals (i.e., similar to receiving transceiver 20 in FIG. 1, discussed above), for example operating according to “WiMAX” technology, also referred to in connection with the IEEE 802.16e standard. Adapter 25 is coupled to host system 30 by bidirectional bus B, via host interface 32 in adapter 25. Host system 30 corresponds to a personal computer, a laptop computer, or any sort of computing device capable of wireless networking in the context of a wireless LAN; of course, the particulars of host system 30 will vary with the particular application. In the example of FIG. 3, wireless network adapter 25 may correspond to a built-in wireless adapter that is physically realized within its corresponding host system 30, to an adapter card installable within host system 30, or to an external card or adapter coupled to host computer 30. The particular protocol and physical arrangement of bus B will, of course, depend upon the form factor and specific realization of wireless network adapter 25. Examples of suitable buses for bus B include PCI, MiniPCI, USB, CardBus, and the like. Host interface 32 connects to bus B, and receives and transmits data from and to host system 30 over bus B, in the manner corresponding to the type of bus used for bus B.

Wireless network adapter 25 in this example includes digital signal processor (DSP) subsystem 35, coupled to host interface 32. The construction of DSP subsystem 35 in connection with this preferred embodiment of the invention, will be described in further detail below. In this embodiment of the invention, DSP subsystem 35 carries out functions involved in baseband processing of the data signals to be transmitted over the wireless network link, and data signals received over that link. In that regard, this baseband processing includes encoding and decoding of the data according to a low density parity check (LDPC) code, and also digital modulation and demodulation for transmission of the encoded data, in the well-known manner for orthogonal frequency division multiplexing (OFDM) or other modulation schemes, according to the particular protocol of the communications being carried out. In addition, DSP subsystem 35 also preferably performs Medium Access Controller (MAC) functions, to control the communications between network adapter 25 and various applications, in the conventional manner.

Transceiver functions are realized by network adapter 25 by the communication of digital data between DSP subsystem 35 and digital up/down conversion function 34. Digital up/down conversion functions 34 perform conventional digital up-conversion of data to be transmitted from baseband to an intermediate frequency, and digital down-conversion of received data from the intermediate frequency to baseband, in the conventional manner. An example of a suitable integrated circuit for digital up/down conversion function 34 is the GC5016 digital up-converter and down-converter integrated circuit available from Texas Instruments Incorporated. Up-converted data to be transmitted is converted from a digital form to the analog domain by digital-to-analog converters 33D, and applied to intermediate frequency transceiver 36; conversely, intermediate frequency analog signals corresponding to those received over the network link are converted into the digital domain by analog-to-digital converters 33A, and applied to digital up/down conversion function 34 for conversion into the baseband. Intermediate frequency transceiver 36 may be realized, for example, by the TRF2432 dual-band intermediate frequency transceiver integrated circuit available from Texas Instruments Incorporated.

Radio frequency (RF) “front end” circuitry 38 is also provided within wireless network adapter 25, in this implementation of the preferred embodiments of the invention. As known in the art, RF front end 38 such analog functions as analog filters, additional up-conversion and down-conversion functions to convert intermediate frequency signals into and out of the high frequency RF signals (e.g., at Gigahertz frequencies, for WiMAX communications) in the conventional manner, and power amplifiers for transmission and receipt of RF signals via antenna A. An example of RF front end 38 suitable for use in connection with this preferred embodiment of the invention is the TRF2436 dual-band RF front end integrated circuit, available from Texas Instruments Incorporated.

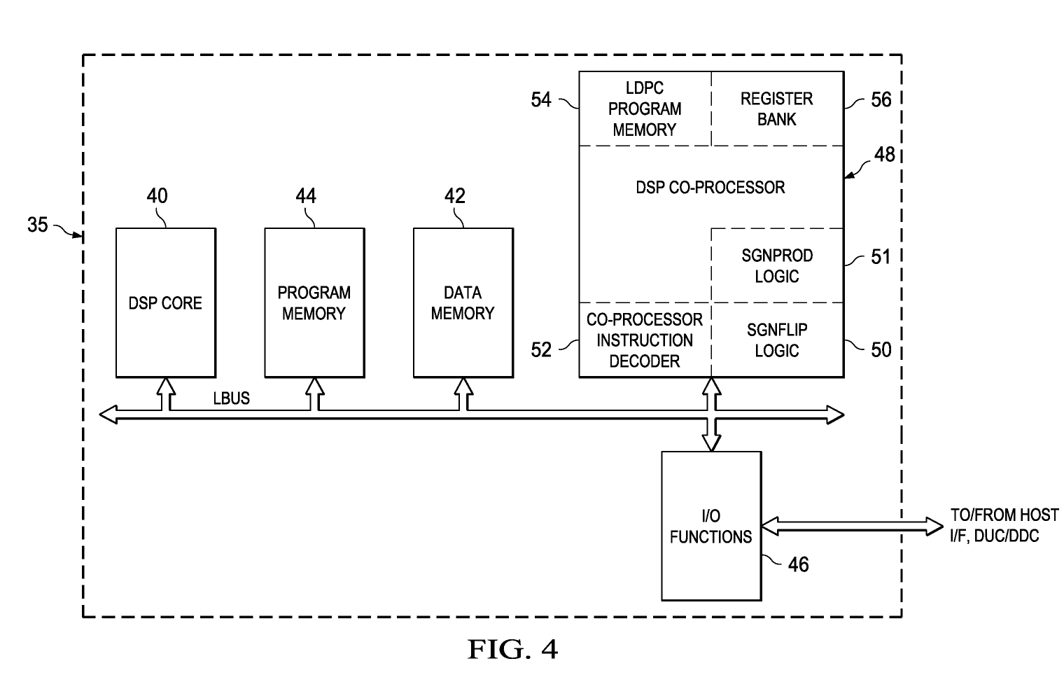

Referring now to FIG. 4, the architecture of DSP subsystem 35 according to the preferred embodiment of the invention will now be described in further detail. According to this embodiment of the invention, DSP subsystem 35 may be realized within a single large-scale integrated circuit, or alternatively by way of two or more individual integrated circuits, depending on the available technology and system requirements.

DSP subsystem 35 includes DSP core 40, which is a full performance digital signal processor (DSP) as a member of the C64x family of digital signal processors available from Texas Instruments Incorporated. As known in the art, this family of DSPs are of the Very Long Instruction Word (VLIW) type, for example capable of pipelining on eight simple, general purpose, instructions in parallel. This architecture has been observed to be particularly well suited for operations involved in the modulation and demodulation of large data block sizes, as involved in digital communications. In this example, DSP core 40 is in communication with local bus LBUS, to which data memory resource 42 and program memory resource 44 are connected in the example of FIG. 4. Of course, data memory 42 and program memory 44 may alternatively be combined within a single physical memory resource, or within a single memory address space, or both, as known in the art; further in the alternative, data memory 42 and program memory 44 may be realized within DSP core 40, if desired. Input/output (I/O) functions 46 are also provided within DSP subsystem 35, in communication with DSP core 40 via local bus LBUS. Input and output operations are carried out by I/O functions 46, for example to and from host interface 32 or digital up/down conversion function 34 (FIG. 3), in the conventional manner.

According to this preferred embodiment of the invention, DSP co-processor 48 is also provided within DSP subsystem 35, and is also coupled to local bus LBUS. DSP co-processor 48 is realized by programmable logic for carrying out the iterative, repetitive, and preferably parallelized, operations involved in LDPC decoding (and, to the extent applicable for transceiver 20, LDPC encoding of data to be transmitted). As such, DSP co-processor 48 appears to DSP core 40 as a traditional co-processor, which DSP core 40 accesses by forwarding to DSP co-processor 48 a higher-level instruction (e.g., DECODE) for execution, along with a pointer to data memory 42 for the data upon which that instruction is to be executed, and a pointer to data memory 42 to the destination location for the results of the decoding.

According to this preferred embodiment of the invention, DSP co-processor 48 includes its own LDPC program memory 54, which stores instruction sequences for carrying out LDPC decoding operations to execute the higher-level instructions forwarded to DSP co-processor 48 from DSP core 40. DSP co-processor 48 also includes register bank 56, or another memory resource or data store, for storing data and results of its operations. In addition, DSP co-processor 48 includes logic circuitry for fetching, decoding, and executing instructions and data involved in its LDPC operations, in response to the higher-level instructions from DSP core 40. For example, as shown in FIG. 4, DSP co-processor 48 includes LDPC instruction decoder 52, for decoding instruction fetched from LDPC program memory 54. The logic circuitry contained within DSP co-processor 48 includes such arithmetic and logic circuitry necessary and appropriate for executing its instructions, and also the necessary memory management and access circuitry for retrieving and storing data from and to data memory 42, such circuitry not shown in FIG. 4 for the sake of clarity. It is contemplated that the architecture and implementation of DSP co-processor 48 may be realized according to a wide range of architectures and designs, depending on the particular need and tradeoffs made by those skilled in the art having reference to this specification.

According to the preferred embodiment of the invention, DSP co-processor 48 includes SGNFLIP logic circuitry 50, which is specific logic circuitry for executing a SGNFLIP instruction useful in the LDPC decoding of a data word. And, according to this preferred embodiment of the invention, SGNFLIP logic circuitry 50 is arranged so the SGNFLIP instruction is executed with minimum latency, and with minimum machine cycles, greatly improving the efficiency of the overall LDPC decoding operation.

According to the preferred embodiment of this invention, the SGNFLIP instruction is an instruction, executable by DSP co-processor 48 or by other programmable digital logic, that performs the function:

SGNFLIP (x, y)=sgn(x)*y

where x and y are n-bit operands, for example as stored in a location of register bank 56 of DSP co-processor 48 (or a register in such other programmable digital logic executing the SGNFLIP instruction). Also according to this preferred embodiment of the invention, an absolute value function (e.g., an ABS(x) instruction) can be evaluated by executing the SGNFLIP instruction using the same operand x as both arguments in the function:

SGNFLIP (x, x)=sgn(x)*x=|x|

In this case, if x is a negative value, multiplying x by its negative sign will return a result equal to the positive magnitude of x; of course, if x is positive, the result will also be the positive magnitude of x.

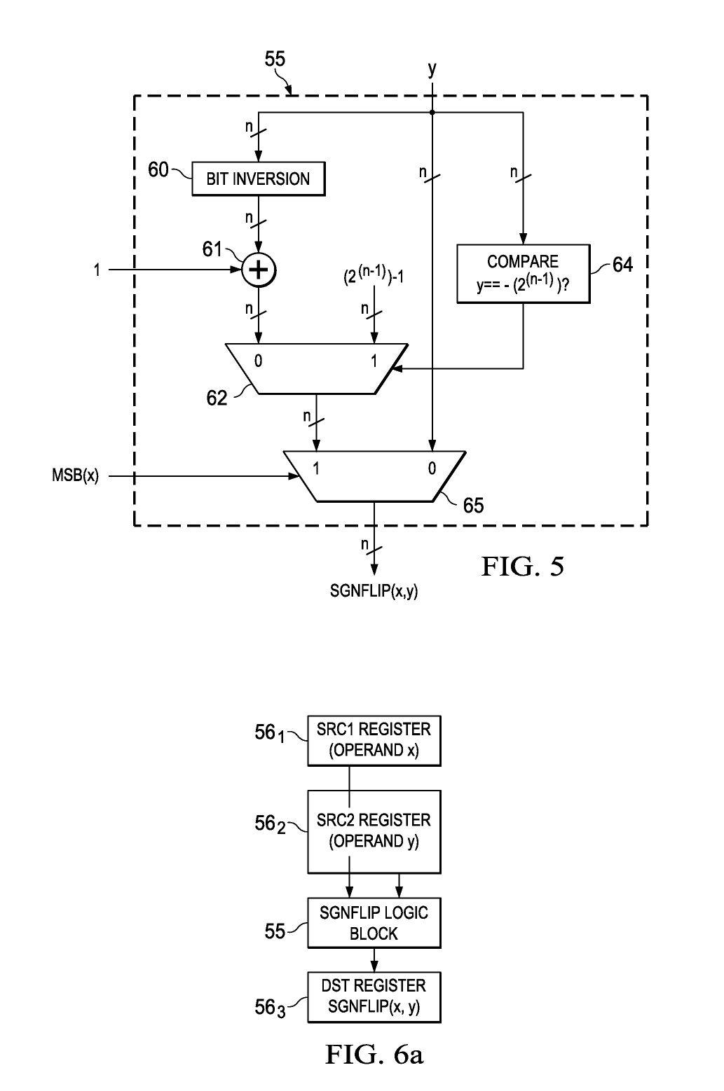

According to this invention, SGNFLIP logic circuitry 50 is arranged to execute this SGNFLIP instruction in an especially efficient manner. FIG. 5 illustrates the construction of logic block 55 in SGNFLIP logic circuitry 50 according to the preferred embodiment of the invention. SGNFLIP logic circuitry 50 may be realized by a single such logic block 55, providing capability for performing a SGNFLIP operation on a single data word at a time. Alternatively, as will be described below, multiple logic blocks 55 may be realized in parallel, within SGNFLIP logic circuitry 50, to perform this operation in parallel on several data words simultaneously; such parallelism will of course be especially useful in applications such as LDPC decoding.

Logic block 55 receives an n-bit digital word (e.g., n=16) corresponding to operand y at one input, and receives the most significant bit of operand x at another input. In this realization, as will become evident from this description, logic block 55 carries out its operations using 2's-complement integer arithmetic. The digital word corresponding to operand y is applied to bit inversion function 60, which inverts the state of each bit of operand y, bit-by-bit. This bit inverted operand y is applied to incrementer 61, which effectively adds a binary “1” value, producing an n-bit value corresponding to the 2's-complement arithmetic inverse of operand y. This inverse value is applied to one input of multiplexer 62, specifically to the input that is selected by multiplexer 62 in response to a “0” value at its control input. The second input of multiplexer 62, specifically the input selected in response to a “1” value at the control input of multiplexer 62, is the maximum positive value for an n-bit 2's-complement word, namely 2⁽ⁿ⁻¹⁾−1.

The digital word corresponding to operand y is also applied to comparator 64, which compares its value against the maximum negative value for an n-bit 2's-complement digital word, namely −2⁽ⁿ⁻¹⁾. The output of comparator 64 is applied to the control input of multiplexer 62. If operand y represents this maximum negative value, comparator 64 presents a “1” value (i.e., TRUE) to the control input of multiplexer 62; if operand y represents a value other than the maximum negative value, it presents a “0” value (i.e., FALSE) to that input.

The output of multiplexer 62 is applied to one input of multiplexer 65, specifically the input selected by a “1” value at the control input of multiplexer 62. The digital word representing operand y itself is presented to another input of multiplexer 65, specifically the input selected by a “0” value at the control input of multiplexer 65. The sign bit (i.e., the MSB of the n-bit 2's-complement word) of operand x is applied to the control input of multiplexer 65. The output of multiplexer 65 presents the output of logic block 55, as a digital word representing the value of SGNFLIP(x, y).

In operation, operand y itself is presented at one input of multiplexer 65, and multiplexer 62 presents the 2's-complement arithmetic inverse of operand y (as produced by bit inversion 60 and incrementer 61) to a second input of multiplexer 65. The special case in which operand y equals the 2's-complement maximum negative value is handled by comparator 64, which instructs multiplexer 62 to select the hard-wired 2's-complement maximum positive value in that event. As such, multiplexer 65 is presented with the value of operand y and its arithmetic inverse, and selects between these inputs in response to the sign bit of operand x.

Considering the construction of logic block 55 as shown in FIG. 5, it is contemplated that the latency involved in the execution of the SGNFLIP instruction will be minimal. Indeed, considering that none of the inversion and incrementing, comparison, and multiplexing operations in logic block 55 are clocked or conditional, and that each is a relatively simple operation that involve only logic propagation delays, it is contemplated that logic block 55 can be realized in a manner that requires only a single machine cycle for execution, with a latency of one machine cycle.

The SGNFLIP(x, y) function can be expressed in conventional assembly language format by way an instruction with register locations as its arguments:
SGNFLIP src1, src2, dst
   in which register src1 contains a digital value corresponding to operand x, register src2 contains a digital value corresponding to operand y, and register dst is the register location into which the result is to be stored. According to this embodiment of the invention, two or more of these register locations may be the same, such that the result of the instruction may be stored in the register location of one of the source operands, or such that the SGNFLIP instruction returns the absolute value of the operand value (if registers src1, src2 refer to the same register location). For purposes of LDPC decoding, however, it is contemplated that the three register locations will be separate locations. And in this LDPC decoding application, it is contemplated that such other logic within DSP co-processor 48 will readily retrieve the results of the SGNFLIP instruction from this destination register location, for completing the row update process and also for performing the column update processing in LDPC decoding.

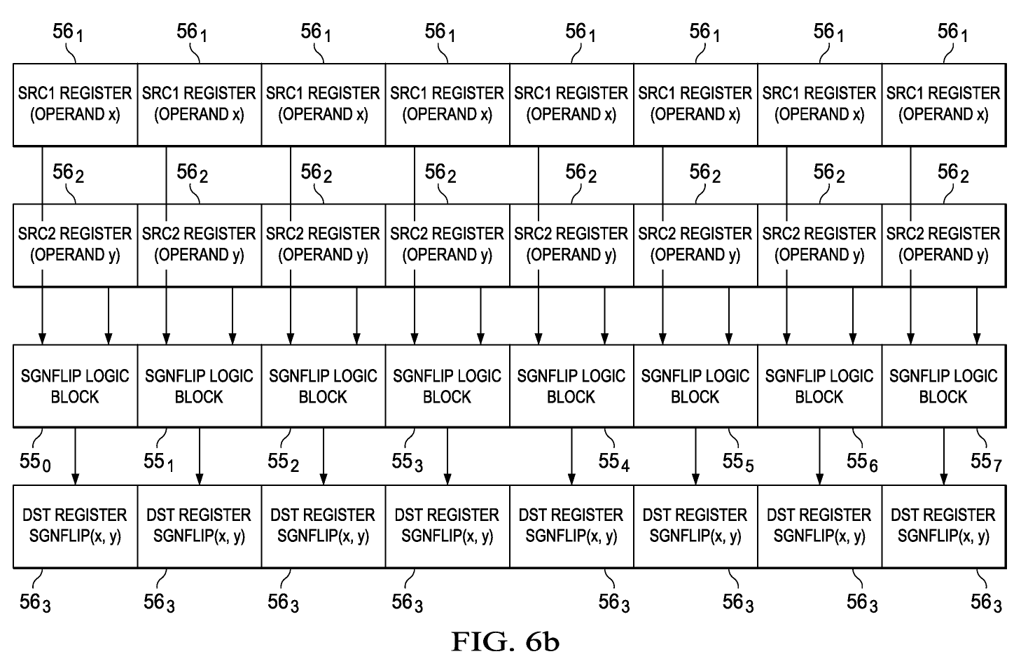

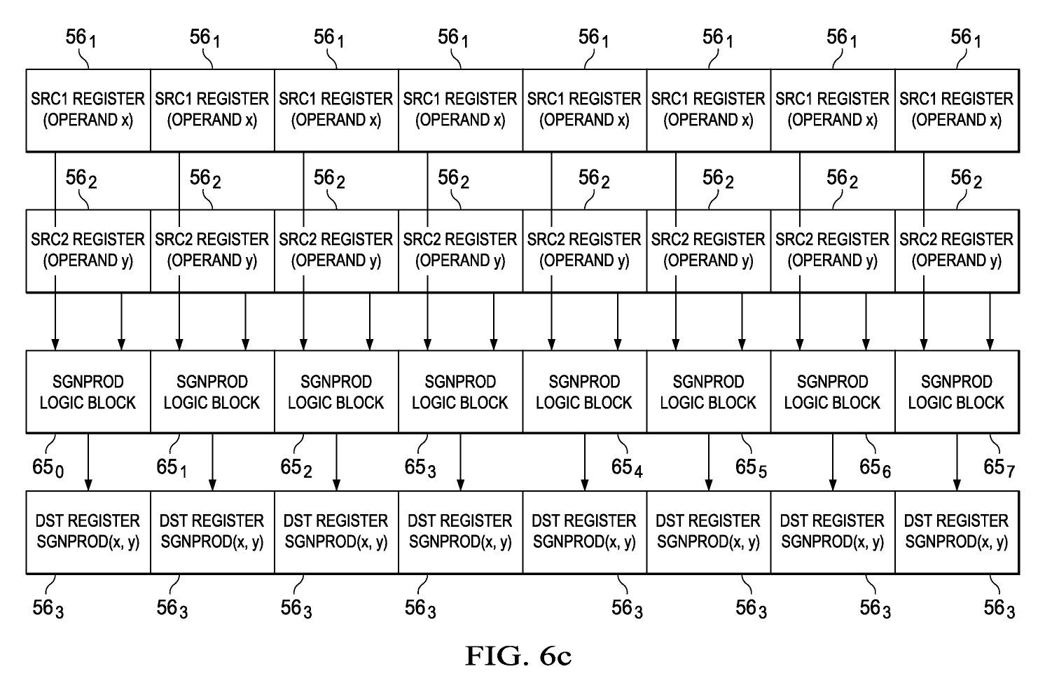

FIG. 6a illustrates the operation of the SGNFLIP instruction according to this preferred embodiment of the invention, as a register-level diagram. As shown in FIG. 6a, operand x is stored in a first source register 56₁ in register bank 56 of DSP co-processor 48, and operand y is stored in a second source register 56₂ in that register bank 56. These two registers 56₁, 56₂ provide their contents to logic block 55, which produces the result SGNFLIP(x, y), and which forwards that result to destination register 56₃, which is also in register bank 56. As discussed above, it is contemplated that the machine cycle latency of this operation will be no more than one machine cycle.

As discussed above in the Background of the Invention, LDPC decoding involves the evaluation of Rₘⱼ=sₘⱼ*Ψ(Aₘⱼ) in the row update process, in which the values Rₘⱼ are recalculated for each updated column estimate for the input nodes, or variable nodes, contributing to that row of the parity check matrix. As such, the SGNFLIP instruction evaluates this function applying Ψ(Aₘⱼ) for a given row and column as the y operand, and the sign value sₘⱼ as the x operand. As also discussed above, conventional assembly code requires nine C64x DSP assembly instructions and thus nine machine cycles to carry out that function, for a single row m and column j. In IEEE 802.16e WiMAX communications, this conventional approach to evaluation of the function z=SGN(x)*Ψ(Aₘⱼ) requires 3,888,000 machine cycles for each code word, in the case of a ¾ code rate with a codeword size of 2304 bits and 576 checksum nodes, and in which the maximum row weighting is fifteen, assuming fifty iterations to convergence.

On the other hand, according to this embodiment of the invention, only a single machine cycle is required for execution of the SGNFLIP instruction by DSP co-processor 48. In LDPC decoding of the same 802.16e codeword of 2304 bits, with 576 checksum nodes, a ¾ code rate, and maximum row weighting of fifteen, only 432,000 machine cycles are required, over the same fifty iterations. In addition, the total latency for this operation is reduced from a maximum of eighteen machine cycles for the conventional case, to a single machine cycle. Other code rates, codeword sizes, etc. will also see a reduction in the computational time by a factor of nine, according to this embodiment of the invention.

As mentioned above, logic block 55 is described as operating on sixteen-bit digital words, one at a time. However, many modern DSP integrated circuits and other programmable logic have much wider datapaths than sixteen bits. For example, it is contemplated that some modern processors, including DSPs, have or will realized data paths as wide as 128 bits for each data word, covering eight sixteen-bit data words.

It has been discovered, according to this preferred embodiment of the invention, that LDPC decoding row update operations, including the SGNFLIP function, can be readily parallelized, in that each data value used in each row update operation is independent and not affected by other data values. In other words, the column updates for an iteration are performed and are complete prior to initiating the next row update operation using those column updates. Accordingly, SGNFLIP logic circuitry 50 of DSP co-processor 48 can be realized by way of eight parallel logic blocks 55, each operating independently on their own individual sixteen-bit data words. FIG. 6b illustrates this parallelism, in a register-level diagram. In this regard, it is contemplated that register bank 56 can include register locations that are as wide (e.g., 128 bits) as the eight data words to be operated upon, such that one register location 56₁ can serve as the src1 register containing operand x for each of the eight operations, and one register location 56₂ can serve as the src2 register containing operand y for those operations. The result of the SGNFLIP instruction as executed by SGNFLIP logic circuitry 50, for each of the eight calculations, is then stored in a single register location 56₃ in register bank 56.

It is also contemplated that this parallelism can be easily generalized for other data word widths fitting within the ultra-wide data path. For example, if the data word (i.e., operand precision) is thirty-two bits in width, each pair of logic blocks 55 can be combined into a single thirty-two bit logic block, providing four thirty-two bit SGNFLIP operations in parallel within SGNFLIP logic circuitry 50. It is contemplated that the logic involved in selectably combining pairs of logic blocks 55 can be readily derived by those skilled in the art having reference to this specification, for a given desired data path width, operand precision, and number of operations to be performed in parallel.

According to another preferred embodiment of the invention, DSP co-processor 48 includes SGNPROD logic circuitry 51, which is specific logic circuitry for executing a SGNPROD instruction that is also useful in the LDPC decoding of a data word. As will be described in further detail below, according to this preferred embodiment of the invention, this SGNPROD instruction can be executed with minimum latency, and with minimum machine cycles. The efficiency of the LDPC decoding process can also be improved by way of this SGNPROD logic circuitry 51.

In addition, those skilled in the art having reference to this specification will readily recognize that SGNPROD logic circuitry 51 can be realized in combination with SGNFLIP logic circuitry 50 described above. Alternatively, either of SGNPROD logic circuitry 51 and SGNFLIP logic circuitry 50 may be implemented individually, without the presence of the other, if the LDPC or other DSP operations to be performed by DSP co-processor 48 warrant; furthermore, either or both of these logic circuitry functions may be realized within DSP core 40, or in some other arrangement as desired for the particular application.

According to the preferred embodiment of this invention, the SGNPROD instruction is an instruction that is executable by DSP co-processor 48, or alternatively by other programmable digital logic, to evaluate the function:

SGNPROD(x, y)=sgn(x)*sgn(y)

where x and y are n-bit operands, for example as stored in a location of register bank 56 of DSP co-processor 48 (or a register in such other programmable digital logic executing the SGNFLIP instruction). This SGNPROD function returns a value of +1, if the signs of operands x, y are both positive or both negative, or a value of −1, if the signs of operands x, y are opposite from one another; this result is preferably communicated as a 2's-complement value (i.e., 0b00000001 for +1, and 0b11111111 for −1).

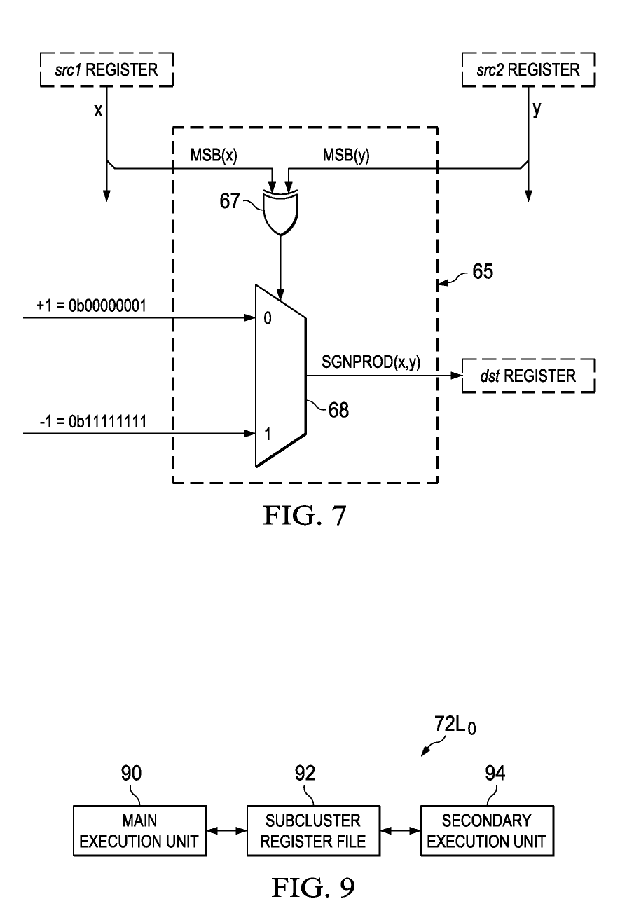

FIG. 7 illustrates the construction of an instance of logic block 65, by way of which SGNPROD logic circuitry 51 may be constructed according to the preferred embodiment of the invention. As in the case of SGNFLIP logic circuitry 50, SGNPROD logic circuitry 51 may be realized by a single such logic block 65 to evaluate the SGNPROD function on a single data word. Alternatively, as shown in FIG. 6c and similarly as described above relative to FIGS. 6a and 6b, parallel logic blocks 65 may be implemented within SGNPROD logic circuitry 51 to perform this operation in parallel on several data words simultaneously. As evident from the foregoing description, this parallelism is especially beneficial in LDPC decoding and similar processing.

Logic block 65 receives n-bit digital words (e.g., n=8) corresponding to operands x and y at its inputs. As suggested in FIG. 7, these two input operands x and y are contemplated to be received from source register locations src1, src2, respectively, in register bank 56. More specifically, because logic block 65 carries out its operations using 2's-complement integer arithmetic, logic block 65 receives the most significant bit (i.e., the sign bit) of operands x and y, which are applied to exclusive-OR function 67. Exclusive-OR 67 produces an output corresponding to the exclusive-OR of these two sign bits; this output is connected to the control input of multiplexer 68. Multiplexer 68 receives two hard-wired multiple-bit input values at its two data inputs. According to this 2's-complement implementation, multiplexer 68 receives an n-bit word of value +1 (e.g., 0b00000001) at its input that is selected by a “0” control value, and an n-bit word of value −1 (e.g., 0b11111111) at its input that is selected by a “1” control value. The data input value selected by multiplexer 68 is forwarded, for example to destination register dst in register bank 56, as the result of the function SGNPROD(x,y).

In operation, therefore, logic block 65 produces either the 2's-complement word for the value +1 or the 2's-complement word for the value −1 in response to the exclusive-OR of the sign bits of operands x and y, which corresponds to the product of these two signs. And considering the construction of logic block 65, involving only a single logic function (exclusive-OR function 67) and a single multiplexer (multiplexer 68) with hard-wired inputs, the time required for evaluation of the SGNPROD(x,y) is only the propagation delays of the signals through these two circuits. The execution of the SGNPROD instruction can therefore be accomplished well within a single machine cycle, with a latency of only a single machine cycle.

The SGNPROD(x, y) function can be expressed in conventional assembly language format by way of an instruction with register locations as its arguments:
SGNPROD src1, src2, dst
   in which register src1 contains a digital value corresponding to operand x, register src2 contains a digital value corresponding to operand y, and register dst is the register location into which the result is to be stored, all such registers preferably located within register bank 56 of DSP co-processor 48. For purposes of LDPC decoding, as in the case of the SGNFLIP instruction described above, it is contemplated that such other logic within DSP co-processor 48 will readily retrieve the results of the SGNPROD instruction from this destination register location, for completing the row update process and also for performing the column update processing in LDPC decoding.

It is contemplated that the register-level representation of the SGNPROD function executed by logic block 65 will correspond to that shown for the SGNFLIP instruction in FIG. 6a. And it is further contemplated that, because only a single machine cycle is required for execution of the SGNPROD instruction by DSP co-processor 48, the number of machine cycles required for the execution of this instruction in a typical LDPC decoding operation will be significantly fewer than in conventional circuitry. For this example, the machine cycles required for the product of signs in the row updates in the LDPC decoding of codeword of 2304 bits, with 576 checksum nodes, a ¾ code rate, and maximum row weighting of fifteen, according to this embodiment of the invention, will be only 432,000 machine cycles, as compared with the 2,592,000 required for conventional circuitry, both over fifty iterations. In addition, the total latency for this operation is reduced from a maximum of eleven machine cycles for the conventional case, to a single machine cycle. Other code rates, codeword sizes, etc. will also see a reduction in the computational time by a factor of six, according to this embodiment of the invention.

As mentioned above, logic block 65 is described as operating on two digital words at a time. However, as discussed above, many modern DSP integrated circuits and other programmable logic have very wide datapaths. Therefore, as in the case of SGNFLIP logic circuitry 50 described above relative to FIG. 6b, it is contemplated that SGNPROD logic circuitry 51 may also be realized in DSP co-processor 48 by way of parallel logic blocks 55, each operating independently on their own individual data words. FIG. 6c illustrates such a parallel arrangement of SGNPROD logic circuitry 51, in which eight parallel logic blocks 65 each operate independently on their own individual sixteen-bit data words. As in the case of FIG. 6b described above, register bank 56 includes register locations that are as wide (e.g., 128 bits) as the eight data words to be operated upon, such that one register location 56₁ can serve as the src1 register containing operand x for each of the eight SGNPROD operations, and one register location 56₂ can serve as the src2 register containing operand y for those operations. The result of the SGNPROD instruction executed by the eight logic blocks 65₀ through 65₇ of SGNPROD logic circuitry 51 is then stored in a single register location 56₃ in register bank 56. Of course, the number of parallel logic blocks 65 implemented within SGNPROD logic circuitry 51, and the data path width of those logic blocks 65, can be varied to fit within the ultra-wide data path available in DSP coprocessor 48.

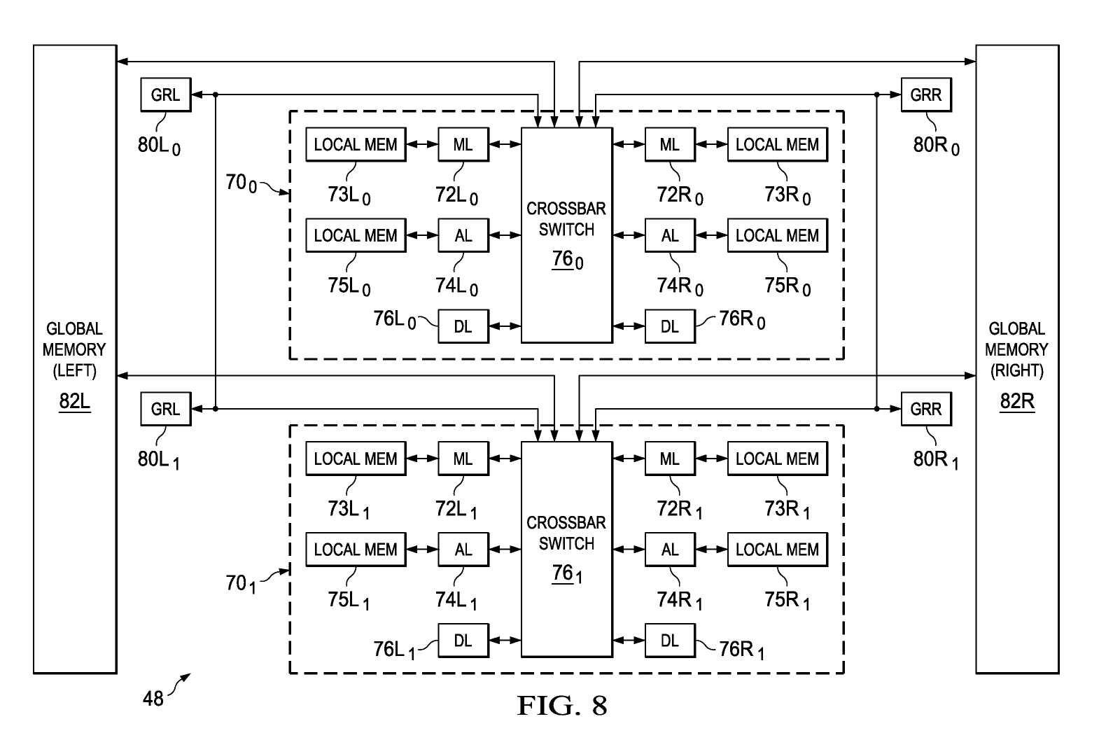

Referring now to FIG. 8, the architecture of DSP co-processor 48 according to a preferred implementation of DSP subsystem 35 of FIG. 4, and constructed according to the preferred embodiments of this invention, will now be described in further detail. As mentioned above, the task of LDPC decoding is carried out on codewords that can be quite long (2000+ bits), in an iterative fashion according to the belief propagation algorithm. Other digital signal processing operations, particularly those including Discrete Fourier Transform and inverse transforms, are also performed on large data blocks, and in an iterative or otherwise repetitive fashion. It has been discovered that additional parallelism in the architecture of DSP co-processor 48, beyond the parallelism of logic blocks 55, 65 in SGNFLIP logic circuitry 50 and SGNPROD logic circuitry 51, respectively, still further improves the performance of DSP subsystem 35 for LDPC decoding and the execution of other computationally intensive DSP routines.

The architecture of DSP co-processor 48, as shown in FIG. 8, is a cluster-based architecture, in that multiple processing clusters 70 are provided within DSP co-processor 48, such clusters 70 being in communication with one another and in communication with memory resources, such as global memories 82L, 82R. In the example of FIG. 8, two similarly constructed clusters 70₀, 70₁ are shown; it is contemplated that a modern implementation of DSP co-processor 48 will include four or more such clusters 70, but only two clusters 70₀, 70₁ are shown in FIG. 8 for clarity. Each of clusters 70₀, 70₁ are connected to global memory (left) 82L and to global memory (right) 82R, and can access each of those memory resources to load data therefrom and to store data therein. Global memories 82L, 82R are realized within DSP co-processor 48, in this embodiment of the invention. Alternatively, if global memories 82L, 82R are realized as part of data memory 42 (FIG. 4), circuitry can be provided within DSP co-processor 48 to communicate with those resources via local bus LBUS.

Referring to cluster 70₀ by way of example (it being understood that cluster 70₁ is similarly constructed), six sub-clusters 72L₀, 74L₀, 76L₀, 72R₀, 74R₀, 76R₀ are present within cluster 70₀. According to this implementation, each sub-cluster 72L₀, 74L₀, 76L₀, 72R₀, 74R₀, 76R₀ is constructed to execute certain generalized arithmetic or logic instructions in common with the other sub-clusters 72L₀, 74L₀, 76L₀, 72R₀, 74R₀, 76R₀, and is also constructed to perform certain instructions with particular efficiency. For example, as suggested by FIG. 8, sub-clusters 72L₀ and 72R₀ are multiplying units, and as such include multiplier circuitry; sub-clusters 74L₀ and 74R₀ are arithmetic units, with particular efficiencies for certain arithmetic and logic instructions; and sub-clusters 76L₀, 76R₀ are data units, constructed to especially be efficient in data load and store operations relative to memory resources outside of cluster 70₀.

According to this implementation, each sub-cluster 72L₀, 74L₀, 76L₀, 72R₀, 74R₀, 76R₀ is itself realized by multiple execution units. By way of example, FIG. 9 illustrates the construction of sub-cluster 72L₀; it is to be understood that the other sub-clusters 74L₀, 76L₀, 72R₀, 74R₀, 76R₀ are similarly constructed, with perhaps differences in the specific circuitry contained therein according to the function (multiplier, arithmetic, data) for that sub-cluster. As shown in FIG. 9, this example of sub-cluster 72L₀ includes main execution unit 90, secondary execution unit 94, and sub-cluster register file 92 accessible by each of main execution unit 90 and secondary execution unit 94. As such, each of sub-clusters 72L₀, 74L₀, 76L₀, 72R₀, 74R₀, 76R₀ is capable of executing two instructions simultaneously, each with access to sub-cluster register file 92. As a result, referring back to FIG. 8, because six sub-clusters 72L₀, 74L₀, 76L₀, 72R₀, 74R₀, 76R₀ are included within cluster 70₀, cluster 70₀ is capable of executing twelve instructions simultaneously, assuming no memory or other resource conflicts.

According to the preferred embodiments of the invention, SGNFLIP logic circuitry 50 and SGNPROD logic circuitry 51 can be implemented in each of main execution unit 90 and secondary execution unit 94, in each of sub-clusters 72L₀, 74L₀, 76L₀, 72R₀, 74R₀, 76R₀ in cluster 70₀; by extension, each of sub-clusters sub-cluster 72L₁, 74L₁, 76L₁, 72R₁, 74R₁, 76R₁ of cluster 70₁ can also each have two instances of each of SGNFLIP logic circuitry 50 and SGNPROD logic circuitry 51. Alternatively, SGNFLIP logic circuitry 50 and SGNPROD logic circuitry 51 can be realized in only one type of sub-clusters 72L₀, 74L₀, 76L₀, 72R₀, 74R₀, 76R₀, for example only in arithmetic sub-clusters 74L₀, 74R₀, if desired. Furthermore, as described above relative to FIG. 6b, each of SGNFLIP logic circuitry 50 and SGNPROD logic circuitry 51 can be constructed as multiple logic blocks 55, 65, respectively, in parallel within one another; this permits each execution unit 90, 94 to be capable of executing up to eight parallel SGNFLIP or SGNPROD instructions simultaneously. Accordingly, as evident from this description, a very high degree of parallelism can be attained by the architecture of DSP co-processor 48 according to these preferred embodiments of the invention.

Referring back to FIG. 8, local memory resources are included within each of clusters 70₀, 70₁. For example, referring to cluster 70₀, local memory resource 73L₀ is bidirectionally coupled to sub-cluster 72L₀, local memory resource 75L₀ is bidirectionally coupled to sub-cluster 74L₀, local memory resource 73R₀ is bidirectionally coupled to sub-cluster 72R₀, and local memory resource 75R₀ is bidirectionally coupled to sub-cluster 74R₀. Each of these local memory resources 73, 75 are associated with, and useful with only, its associated sub-cluster 72, 74, respectively. As such, each sub-cluster 72, 74 can write to and read from its associated local memory resource 73, 75 very rapidly, for example within a single machine cycle; local memory resources 73, 75 are therefore useful for storage of intermediate results, such as row and column update values in LDPC decoding.

Each sub-cluster 72, 74, 76 in cluster 70₀ is bidirectionally connected to crossbar switch 76₀. Crossbar switch 76₀ manages the communication of data into, out of, and within cluster 70₀, by coupling individual ones of the sub-clusters 72, 74, 76 to another sub-cluster within cluster 70₀, or to a memory resource. As discussed above, these memory resources include global memory (left) 82L and global memory (right) 82R. As evident in FIG. 8, each of clusters 70₀, 70₁ (more specifically, each of sub-clusters 72, 74, 76 therein) can access each of global memory (left) 82L and global memory (right) 82R, and as such global memories 82L, 82R can be used to communicate data among clusters 70. Preferably, the sub-clusters 72, 74, 76 are split so that each sub-cluster can access one of global memories 82L, 82R through crossbar switch 76, but not the other. For example, referring to cluster 70₀, sub-clusters 72L₀, 74L₀, 76L₀ may be capable of accessing global memory (left) 82L but not global memory (right) 82R; conversely, sub-clusters 72R₀, 74R₀, 76RL₀ may be capable of accessing global memory (right) 82R but not global memory (left) 82L. This assigning of sub-clusters 72, 74, 76 to one but not the other of global memories 82L, 82R may facilitate physical layout of DSP co-processor 48, and thus reduce cost.

According to this architecture, global register files 80 provide faster data communication among clusters 70. As shown in FIG. 8, global register files 80L₀, 80L₁, 80R₀, 80R₁ are connected to each of clusters 70₀, 70₁, specifically to crossbar switches 76₀, 76₁, respectively, within clusters 70₀, 70₁. Global register files 80 preferably include addressable memory locations that can be written to and read from rapidly, in fewer machine cycles, than can global memories 82L, 82R; on the other hand, global register files 80 must be kept relatively small in capacity to permit such high-performance access. For example, it is contemplated that two machine cycles are required to write a data word into a location of global register file 80, and one machine cycle is required to read a data word from a location of global register file 80; in contrast, it is contemplated that as many as seven machine cycles are required to write data into, or read data from, a location in global memories 82L, 82R. Accordingly, global register files 80 provide a rapid path for communication of data from cluster-to-cluster; a sub-cluster in one cluster 70 writes data into a location of one of global register files 80, and a sub-cluster in another cluster 70 reads that data from that location.

It is contemplated that the architecture of DSP co-processor 48 described above relative to FIGS. 8 and 9 will especially benefit from the preferred embodiments of this invention, especially in connection with the LDPC decoding of large codewords as described above. This particular benefit derives largely from the high level of parallelism provided by this invention, in combination with the LDPC decoding application and the large codewords now being used in modern communications. However, those skilled in the art having reference to this specification will readily appreciate that this invention may be readily realized in other computing architectures, and will be useful in connection with a wide range of applications and uses. The detailed description provided in this specification will therefore be understood to be presented by way of example only.

While the invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. Programmable digital logic circuitry, comprising:
program memory for storing a plurality of program instructions arranged in a sequence, the plurality of program instructions comprising a first program instruction corresponding to a SGNFLIP function of a first and a second operand, the SGNFLIP function returning a value corresponding to the signed magnitude of the second operand multiplied by the sign of the first operand;
a register bank for storing operands; and
a first logic block for executing the first program instruction upon first and second operands stored in the register bank.

2. The circuitry of claim 1, wherein the first program instruction specifies first and second source register locations of the register bank at which the first and second operands, respectively, are stored.

3. The circuitry of claim 2, wherein, for at least one instance of the first program instruction, the first and second source register locations are the same register location.

4. The circuitry of claim 2, wherein the first program instruction also specifies a destination register location of the register bank at which to store a result from executing the first program instruction.

5. The circuitry of claim 1, wherein the logic circuitry comprises:
a plurality of the logic blocks, each of the logic blocks for executing the first program instruction upon a pair of operands stored in the register bank;
wherein each of the first and second register locations of the register bank store a plurality of operands;
and wherein, in executing the first program instruction, a plurality of operands from the first and second register locations of the register bank are applied to corresponding ones of the plurality of the logic blocks, so that the plurality of logic blocks each return a value corresponding to the signed magnitude of a corresponding second operand multiplied by the sign of a corresponding first operand.

6. The circuitry of claim 1, wherein the logic block comprises:
inversion circuitry, having an input receiving the second operand, and for producing an arithmetic inverse of the value of the second operand;
a first multiplexer, having a first input coupled to the inversion circuitry, having a second input coupled to receive the second operand; and having a control input for receiving a sign signal corresponding to a sign of the first operand, for presenting one of the first and second inputs at its output responsive to the sign of the first operand.

7. The circuitry of claim 6, wherein the inversion circuitry comprises:
bit inversion circuitry, for inverting the second operand bit-by-bit;
an incrementer, for incrementing the inverted second operand to produce a 2's complement inverse of the value of the second operand;
and wherein the logic block further comprises:
a comparator, for comparing the value of the second operand with a maximum negative value;
a second multiplexer, having a first input receiving the output of the inversion circuitry, a second input receiving a maximum positive value, an output coupled to the first input of the first multiplexer, and a control input coupled to receive an output from the comparator, for presenting the maximum positive value at its second input to the first multiplexer responsive to the comparator determining that the value of the second operand is at the maximum negative value.

8. A processor system, comprising:
a main processor, comprising programmable logic for executing program instructions, coupled to a local bus;
a memory resource coupled to the local bus, the memory resource comprising addressable memory locations for storing program instructions and program data;
a co-processor, coupled to the local bus, for executing program instructions called by the main processor, the co-processor comprising:
program memory for storing a plurality of program instructions arranged in a sequence, the plurality of program instructions comprising a first program instruction corresponding to a SGNFLIP function of a first and a second operand, the SGNFLIP function returning a value corresponding to the signed magnitude of the second operand multiplied by the sign of the first operand;
a register bank for storing operands; and
a first logic block for executing the first program instruction upon first and second operands stored in the register bank.

9. The system of claim 8, wherein the first program instruction specifies first and second source register locations of the register bank at which the first and second operands, respectively, are stored.

10. The system of claim 9, wherein, for at least one instance of the first program instruction, the first and second source register locations are the same register location.

11. The system of claim 8, wherein the co-processor comprises:
a plurality of the logic blocks, each of the logic blocks for executing the first program instruction upon a pair of operands stored in the register bank;
wherein each of the first and second register locations of the register bank store a plurality of operands;
and wherein, in executing the first program instruction, a plurality of operands from the first and second register locations of the register bank are applied to corresponding ones of the plurality of the logic blocks, so that the plurality of logic blocks each return a value corresponding to the signed magnitude of a corresponding second operand multiplied by the sign of a corresponding first operand.

12. The system of claim 8, wherein the logic block comprises:
inversion circuitry, having an input receiving the second operand, and for producing an arithmetic inverse of the value of the second operand;
a first multiplexer, having a first input coupled to the inversion circuitry, having a second input coupled to receive the second operand; and having a control input for receiving a sign signal corresponding to a sign of the first operand, for presenting one of the first and second inputs at its output responsive to the sign of the first operand.

13. The system of claim 12, wherein the inversion circuitry comprises:
bit inversion circuitry, for inverting the second operand bit-by-bit;
an incrementer, for incrementing the inverted second operand to produce a 2's complement inverse of the value of the second operand;
and wherein the logic block further comprises:
a comparator, for comparing the value of the second operand with a maximum negative value;
a second multiplexer, having a first input receiving the output of the inversion circuitry, a second input receiving a maximum positive value, an output coupled to the first input of the first multiplexer, and a control input coupled to receive an output from the comparator, for presenting the maximum positive value at its second input to the first multiplexer responsive to the comparator determining that the value of the second operand is at the maximum negative value.

14. A method of operating logic circuitry to execute a program instruction to return an output value corresponding to the product of a second operand with the sign of a first operand, comprising the steps of:
inverting the value of the second operand;
selecting between the inverted value of the second operand and the value of the second operand itself, responsive to the sign of the first operand, to produce the output value.

15. The method of claim 14, wherein the inverting step produces the 2's-complement inverse of the value of the second operand.

16. The method of claim 15, wherein the inverting step comprises:
bit-by-bit inverting the value of the second operand;
incrementing the bit-by-bit inverted value by one.

17. The method of claim 15, further comprising:
comparing the value of the second operand with a maximum 2's-complement negative value;
selecting a maximum 2's-complement positive value as the inverted value of the second operand responsive to the comparing step determining that the second operand equals the maximum 2's complement negative value; and
selecting the 2's complement inverse of the second operand as the inverted value of the second operand responsive to the comparing step determining that the second operand does not equal the maximum 2's complement negative value.

18. The method of claim 15, further comprising:
before the inverting and selecting steps, retrieving values of the first and second operands from a register bank; and
after the selecting step, storing the output value in the register bank.

19. The method of claim 18, wherein the retrieving step retrieves a plurality of values of the first and second operands from the register bank;
wherein the inverting and selecting steps are performed for each of the pluralities of values of the first and second operands retrieved in the retrieving steps, to produce a plurality of output values;
and wherein the storing step stores the plurality of output values in the register bank.

20. Programmable digital logic circuitry, comprising:
program memory for storing a plurality of program instructions arranged in a sequence, the plurality of program instructions comprising a first program instruction corresponding to a SGNPROD function of a first signed operand and a second signed operand, the SGNPROD function returning a value corresponding to a product of the signs of the first and second operands;
a register bank for storing operands; and
a first logic block for executing the first program instruction upon first and second operands stored in the register bank.

21. The circuitry of claim 20, wherein the first program instruction specifies first and second source register locations of the register bank at which the first and second operands, respectively, are stored.

22. The circuitry of claim 21, wherein the first program instruction also specifies a destination register location of the register bank at which to store a result from executing the first program instruction.

23. The circuitry of claim 20, wherein the logic circuitry comprises:
a plurality of the logic blocks, each of the logic blocks for executing the first program instruction upon a pair of operands stored in the register bank;
wherein each of the first and second register locations of the register bank store a plurality of operands;
and wherein, in executing the first program instruction, a plurality of operands from the first and second register locations of the register bank are applied to corresponding ones of the plurality of the logic blocks, so that the plurality of logic blocks each return a value corresponding to a product of the signs of the first and second operands.

24. The circuitry of claim 20, wherein the logic block comprises:
exclusive-OR circuitry, having an input receiving a sign bit of the first operand, having an input receiving a sign bit of the second operand, and for producing an output signal corresponding to the exclusive-OR of the sign bits of the first and second operands;
a multiplexer, having a first input receiving a data word representing a value of +1, having a second input receiving a data word representing a value of −1, having a control input for receiving the output signal from the exclusive-OR circuitry, for presenting one of the first and second inputs at its output responsive to the value of the output signal from the exclusive-OR circuitry.

25. A processor system, comprising:
a main processor, comprising programmable logic for executing program instructions, coupled to a local bus;
a memory resource coupled to the local bus, the memory resource comprising addressable memory locations for storing program instructions and program data;
a co-processor, coupled to the local bus, for executing program instructions called by the main processor, the co-processor comprising:
program memory for storing a plurality of program instructions arranged in a sequence, the plurality of program instructions comprising a first program instruction corresponding to a SGNPROD function of a first signed operand and a second signed operand, the SGNPROD function returning a value corresponding to a product of the signs of the first and second operands;
a register bank for storing operands; and
a first logic block for executing the first program instruction upon first and second operands stored in the register bank.

26. The system of claim 25, wherein the first program instruction specifies first and second source register locations of the register bank at which the first and second operands, respectively, are stored.

27. The system of claim 25, wherein the logic circuitry comprises:
a plurality of the logic blocks, each of the logic blocks for executing the first program instruction upon a pair of operands stored in the register bank;
wherein each of the first and second register locations of the register bank store a plurality of operands;
and wherein, in executing the first program instruction, a plurality of operands from the first and second register locations of the register bank are applied to corresponding ones of the plurality of the logic blocks, so that the plurality of logic blocks each return a value corresponding to a product of the signs of the first and second operands.

28. The system of claim 25, wherein the logic block comprises:
exclusive-OR circuitry, having an input receiving a sign bit of the first operand, having an input receiving a sign bit of the second operand, and for producing an output signal corresponding to the exclusive-OR of the sign bits of the first and second operands;
a multiplexer, having a first input receiving a data word representing a value of +1, having a second input receiving a data word representing a value of −1, having a control input for receiving the output signal from the exclusive-OR circuitry, for presenting one of the first and second inputs at its output responsive to the value of the output signal from the exclusive-OR circuitry.

29. The system of claim 25, wherein the plurality of program instructions further comprises:
a second program instruction corresponding to a SGNFLIP function of a third and a fourth operand, the SGNFLIP function returning a value corresponding to the signed magnitude of the fourth operand multiplied by the sign of the third operand;
and wherein the co-processor further comprises:
a second logic block for executing the second program instruction upon third and fourth operands stored in the register bank.

30. A method of operating logic circuitry to execute a program instruction to return an output value corresponding to the product of the sign of a first operand with the sign of a second operand, comprising the steps of:
evaluating the exclusive-OR of sign bits of the first and second operands;
selecting between a data word representing a value of +1, and a data word representing a value of −1, responsive to the result of the evaluating step, to produce the output value.

31. The method of claim 30, wherein the data word representing a value of +1 and the data word representing a value of −1 are digital data words in 2's-complement form.

32. The method of claim 30, further comprising:
before the evaluating and selecting steps, retrieving values of the first and second operands from a register bank; and
after the selecting step, storing the output value in the register bank.

33. The method of claim 32, wherein the retrieving step retrieves a plurality of values of the first and second operands from the register bank;
wherein the evaluating and selecting steps are performed for each of the pluralities of values of the first and second operands retrieved in the retrieving steps, to produce a plurality of output values;
and wherein the storing step stores the plurality of output values in the register bank.
